(19) United States
(12) Patent Application Publication
(10) Pub. No.: US 2007/0055044 A1
(43) Pub. Date: Mar. 8, 2007

(54) Cross-linkable base layer for interlinings applied in a double-dot method

(75) Inventors: Ulrich Simon, Herne (DE); Andreas Pawlik, Recklinghausen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 10/575,110

(22) PCT Filed: Aug. 16, 2004
(86) PCT No.: PCT/EP04/51804

§ 371 Date: Apr. 10, 2006

(30) Foreign Application Priority Data
Oct. 9, 2003 (DE) 103 47 628.8

(51) Int. Cl. C08G 69/08

(52) U.S. Cl. 528/310

(57) ABSTRACT

Interlining with a double dot for the coating and/or lamination of sheetlike structures, wherein upper dot and lower dot are based on an amine-terminated, crosslinkable copolyamide and the lower dot further comprises a crosslinker and an acrylic and/or PUR dispersion.

The invention relates to a crosslinkable hotmelt adhesive coating based on a powder mixture comprising a commercially customary, amine-terminated copolyamide free and a pulverized or blocked isocyanate, an aqueous epichlorohydrin or a liquid or solid epoxide, for producing a base dot as a barrier to strikeback in double dot coating. The upper dot consists of an amine-regulated copolyamide, in order to ensure good attachment to the lower dot. The invention relates in particular to a hotmelt adhesive composition for the halftone coating of bondable interlinings for the clothing industry, especially outerwear.

In order to solve the problems regarding the reduced resistance to laundering and dry cleaning and regarding the relatively weak adhesion, improved hotmelt adhesive compositions, but also improved coating technologies, have been developed. Duodot or double dot coatings are described, for example, in the patents DE-B 22 14 236, DE-B 22 31 723, DE-B 25 36 911 and DE-B 32 30 579.

The coating supports have been improved by using finer yarns with low-denier individual fibers down to the microfiber range and also synthetic yarns, examples being high-bulk acrylic or polyester yarns. The wovens originally used have largely been replaced by stitch-bonded fabrics, which are a combination of nonwovens and knitted fabrics. These new combinations lead to very soft but also very open constructions which place even greater requirements on the coating methods and hotmelt adhesive compositions, especially with regard to strikeback and strikethrough of the hotmelt adhesive composition.

Costs and quality reasons have led to a marked reduction in the amount of coating applied per m² of interlining material. Whereas formerly the amounts applied were commonly 10-20 g/m², they are nowadays 7-12 g/m². Despite these small amounts, it is necessary to ensure sufficient adhesion and resistance; in other words, the hotmelt adhesive must not strike away into the inter-lining, since then it would no longer be available for the actual bonding.

The object on which the invention was based, therefore, was to find an effective strikeback barrier which with a reduced amount of coating features high bond strength, good attachment of the upper dot to the base layer and good resistance to laundering and dry cleaning.

A range of strikeback barriers are known: crosslinking acrylate dispersions or polyurethane dispersions, or powder-filled pastes based on high-melting acid-regulated copolyamides and polyethylene or on highly viscous thermoplastic polyurethane powders.

All systems have more or less severe disadvantages in terms of application, the attachment to the upper dot or resistance to laundering. In addition, the dispersions cannot be employed on coarse, hairy interlinings.

When self-crosslinking acrylate or polyurethane dispersions are coated, there is partial crosslinking even in the course of coating, which leads to a deposit on the stencils and thus to clogging of the stencil holes. Laborious cleaning of the unit is required. Great difficulties are experienced when there is production-induced standstill. A further problem is the attachment of the upper dot to the base layer. The highly viscous powder-filled systems based on acid-regulated polyamide, polyethylene and polyurethane do not achieve the required strikeback security.

In patent DE 198 08 809 a description is given of how a free isocyanate is stabilized to water. The free isocyanate is incorporated by extrusion into an inert polyethylene matrix and subsequently finely ground again. By this means success was achieved in creating a stable crosslinkable system for the base dot. The disadvantage of this system is the complicated and hence expensive preparation of the water-stable isocyanate; additionally, the polyethylene matrix hinders the diffusion rate, which signifies a reduction in the reaction rate. It has so far not been possible to provide a stable crosslinkable system for the base dot. Either the isocyanates, which are employed preferably, could not be stabilized to water, or the activation temperatures for crosslinking (greater than 145° C.) were too high.

In a preferred embodiment a commercially customary copolyamide with amine end groups is mixed with a passivated trimerized diisocyanate (as described in patent DE 35 17 333 A1) and the mixture is processed as an aqueous paste by rotary screen printing.

It has now surprisingly become possible to prepare a very reactive system in accordance with the claims, having an activation temperature in the range from about 100 to 130° C. and having water resistance. The crosslinkable hotmelt adhesive composition according to the invention for the coating and/or lamination of sheetlike structures has the feature that the reactive components present in the hotmelt adhesive composition do not react, with crosslinking, until in the melt.

Polyisocyanates, particularly solid polyisocyanates, are dispersed with isocyanate-reactive media, such as diamines (hexamethylene diamine), and by that means are surface-stabilized with respect to the surrounding medium. This deactivation is brought about by treating the isocyanate particles on the surface with a deactivating agent in amounts which are stoichiometric with respect to the total isocyanate content. The passivated fraction is in the range from 0.01 to 10%, preferably from 0.1 to 5%.

It is also possible, however, to use other crosslinkers, such as aqueous epichlorhydrin, epoxides or liquid dior triacrylates. In the course of subsequent drying in the oven at about 100 to 130° C., crosslinking is initiated within a few seconds to give a crosslinked strikeback barrier for the double dot. In this way it is possible to avoid the customary problems of isocyanate-containing systems, which are for example that capped isocyanates (with caprolactam or oximes as capping agent or obtained by dimerization) require excessive activation temperatures; furthermore, no extraneous substances should be released in the course of bonding. The other problem was that non-blocked isocyanates react with water while still in the paste.

Suitable isocyanates are solid isocyanates containing more than 2 free NCO groups and having a melting range of from 100 to 130° C. (e.g. Vestanat T 1890 from Degussa AG). The fraction of the polyisocyanate relative to the polyester used is in the range from 3 to 20% by weight, preferably from 5 to 10% by weight. The polymer of the matrix must not react with the isocyanate. Also suitable as crosslinking component are epoxides having a melting range of from 90 to 130° C., preferably from 100 to 120° C., a molecular weight range of from 2 000 to 6 000, preferably 2 500 to 3 000, and more than 2 epoxide groups per molecule; bisphenol A may be mentioned as an example.

A surprising finding was particularly good attachment of the lower dot to the upper dot material employed. The amine-regulated copolyamide, as upper dot material, reacted with the reactive components of the lower dot paste and formed an optimum attachment, which is not possible with normal, acid-regulated polyamides.

Suitable products for the base dot and upper dot are low-melting grades of low viscosity. The melting point should be between 90 and 150∩C, preferably between 115 and 130° C., with a solution viscosity eta rel in the range from 1.2 to 1.7, preferably from 1.25 to 1.5. By this means, the boundary layer reacts with the crosslinker-containing paste and creates a highly stable bonding of the two dots. The coating amounts for the base dot should be from 1.5 to 5 g/m², preferably from 2 to 4 g/m², and for the upper dot, depending on application, should be from 4 to 8 g/m², especially from 5 to 7 g/m². The base dot can be applied as a paste in a halftone formation.

The copolyamides employed are based on lactames (LL, CL), dimer fatty acids and corresponding dicarboxylic acids and diamines having chain lengths from C2 to C15 and piperazine, LL, CL dicarboxylic acids with chain lengths of C₆-C₁₅ and diamines (piperazine, HMD, MPD, IPD and C₉, C₁₀).

The fraction of the polyamide (based on solids content) in the base paste is in the range from 1 to 20% by weight, preferably from 5 to 15% by weight.

As acrylate and/or polyurethane dispersions it is possible to employ all common types. Particularly suitable are self-crosslinking butyl acrylates such as PLEXTOL BV 411 from Degussa AG, for example. Polyamide:acrylate or PU ratio based on the solids: −1:3-1:20, preferably 1:5-1:15.

### EXAMPLES

A powder mixture comprising an amine-regulated copolyamide (VESTAMELT X 1027-P1) and a trimerized polyisocyanate from Degussa (VESTAGON T 1890) was dispersed with a diamine (e.g. hexamethylene diamine) and a common dispersant in water and the dispersion was passivated (diamine in an equimolar deficit relative to NCO groups, 1:50). A common acrylate dispersion, e.g. PLEXTOL BV 441, and a thickener, e.g. Mirox TX, from Stockhausen, were processed to a printable paste, as described in DE-B 20 07 971, DE-B 22 29 308, DE-B 24 07 505 and DE-B 25 07 504, and the paste was printed with a rotary screen printing unit having a CP 66 stencil onto a 25 g polyester knit comprising high-bulk yarn. The amount applied was 3 g/m². VESTAMELT X 1027-P816 was scattered onto the paste dot while the dot was still wet, the excess was removed by suction, and the material was dried and partially sintered in a drying oven at 130° C. The upper dot (VESTAMELT X 1027-P816) had an add-on of 5 g/m², so that the overall weight was 8 g/m².

Paste Formulation of the Base Dot

500 g of water

10 g of Mirox TX (polyacrylic acid derivative)

20 g of Intrasol 12/18/5 (ethoxilated fatty alcohol)

400 g of PLEXTOL BV 441

20 g of VESTAMELT X 1027-P1

3 g of VESTANAT T 1890

0.15 g of hexamethylene diamine

Result

A 5 cm wide strip of this interlining was bonded to a siliconized shirt material comprising a polyester/cotton blend at a joining temperature of 127° C. and a linear pressure of 4 N for 10 s, and then the assembly was subjected to washing at 60° C.

Primary adhesion: 16 N/ 5 cm

60∩C wash: 12 N/ 5 cm

Back-riveting: 0.05 N/10 cm

### Comparative Example 1

### State of the Art

A paste system based on an acid-regulated polyamide and on a polyethylene was applied to the same interlining and the material was scattered with the same upper dot material (VESTAMELT X 1027-P816), dried and sintered. The same amounts of base dot and upper dot were applied.

Paste Formulation

1500 g of water

35 g of Mirox TX

40 g of Intrasol 12/18/5

400 g of Schattifix 1820 (LP polyethylene)

200 g of VESTAMELT 250-P1

Schättifix 1820 is a low-pressure polyethylene having a melting point of 128-130° C. and an MFR of 20 g/10 min.

Result

Primary adhesion: 9 N/5 cm

60∩C wash: 5 N/ 5 cm

Back-riveting: 0.9 N/10 cm

### Comparative Example 2

A paste system based on an acid-regulated polyamide and on an acrylate dispersion was applied to the same interlining and the material was scattered with the same upper dot material (VESTAMELT X 1027-P816), dried and sintered. The same amounts of base dot and upper dot were applied.

Paste Formulation

500 g of water

10 g of Mirox TX

20 g of Intrasol 12/18/5

400 g of PLEXTOL BF 440

Primary adhesion: 6 N/5 cm

60∩C wash: 3 N/5 cm

Back-riveting: 1.9 N/10 cm

The advantage of the new technology is that the lower dot is crosslinked even under the drying conditions and, owing to its amine termination, the upper dot is cross-linked with the lower dot during melting, so giving an optimum attachment. Since there is a sharp increase in the molecular weight of the lower dot following coating, it is no longer able to sink into the knit. In the course of subsequent bonding, the low-viscosity polyamide of the upper dot is compelled to flow against the upper material that is to be bonded, since it is unable to flow off downward, hence giving very high adhesions even with very small amounts of hotmelt adhesive. The parting layer between upper dot and base dot, which hitherto has been the weak point of the system, especially in the course of laundering, is more resistant to hydrolytic attack than prior systems and therefore exhibits substantially higher resistances.

Products Employed

VESTAMELT X 1027-P1 is a ternary copolyamide from Degussa AG with amine end groups, melting point 120∩C, amine end groups 100-400 meq/kg, preferably 250-350 meq/kg.

VESTAMELT X 1027-P816 is a powder mixture of a ternary copolyamide from Degussa AG with amine end groups 100-400 meq/kg, preferably 250-350 meq/kg, melting point 120° C.

VESTANAT T 1890/100 is a polyisocyanate having a functionality of 3-4, its melting point being at 100-115∩C. It is a product of Degussa AG.

PLEXTOL BV 411

PLEXTOL BV 411 is an aqueous dispersion of a self-crosslinking acrylic polymer.

1. A hotmelt adhesive composition for the coating and/or lamination of sheetlike structures, wherein upper dot and lower dot are based on an amine-terminated crosslinkable copolyamide and the lower dot further comprises a crosslinker and an acrylic and/or polyurethane dispersion.

2. A hotmelt adhesive composition as claimed in claim 1, wherein the copolyamide is an amine-regulated copolyamide powder having a melting range of 90 to 150° C. and a solution viscosity eta rel in the range from 1.2 to 1.7.

3. A hotmelt adhesive composition as claimed in claim 1, wherein the upper dot comprises an amine-regulated copolyamide.

4. A hotmelt adhesive composition as claimed in claim 1, wherein the lower dot comprises an amine-regulated copolyamide.

5. A hotmelt adhesive composition as claimed in claim 1, comprising an acrylate dispersion and/or polyurethane dispersion.

6. A hotmelt adhesive composition as claimed claim 1, wherein the crosslinking component comes from the group of the isocyanates and has more than two reactive groups per molecule.

7. A hotmelt adhesive composition as claimed claim 1, wherein the isocyanate has a melting range of from 100 to 130° C.

8. A hotmelt adhesive composition as claimed claim 1, wherein an epoxide having a melting range of from 90 to 130° C., a molecular weight range from 2000 to 6000 and more than two epoxide groups per molecule is employed as crosslinking component.

9. A hotmelt adhesive composition as claimed claim 1, wherein a pulverulent free or blocked isocyanate is employed as crosslinking component.

10. A hotmelt adhesive composition as claimed claim 1, wherein the amine-regulated copolyamides in the upper dot and lower dot have different melting temperatures or viscosities.

11. A hotmelt adhesive composition as claimed claim 1, wherein the crosslinking component is an epichlorohydrin.

12. A hotmelt adhesive composition as claimed claim 1, wherein the acrylic component is a di- and/or triacrylate.

13. A hotmelt adhesive composition as claimed claim 1, wherein the reactive amine-regulated copolyamide is employed as base dot for the double dot technology, as a strikethrough barrier.

14. A hotmelt adhesive composition as claimed claim 1, wherein the base dot consists of a passivated isocyanate and an amine-regulated copolyamide and is applied in halftone formation as a paste.

15. A hotmelt adhesive composition as claimed in claim 1, wherein the crosslinking reaction is accelerated by catalysts.

16. A hotmelt adhesive composition as claimed claim 1, wherein the copolyamides are based on lactames (LL, CL), dimer fatty acids and corresponding dicarboxylic acids and diamines having chain lengths of C2 to C15 and piperazine.

17. A method of using the hotmelt adhesive composition as claimed claim 1 for the coating and/or lamination of sheetlike structures.

18. An interlining material for clothing, which has been provided with a hotmelt adhesive composition as claimed in claim
